(19) United States
(12) Patent Application Publication
(10) Pub. No.: US 2026/0213426 A1
(43) Pub. Date: Jul. 23, 2026

(54) BASE STATION ANTENNAS HAVING RADIATING ELEMENTS WITH CLOAKED DIRECTORS AND/OR MULTIPLE DIRECTORS

(71) Applicant: Outdoor Wireless Networks LLC, Richardson, TX (US)

(72) Inventors: Shreyas SATHE, Kolhapur (IN); Uttarpara GHOSHAL, Uttarpara (IN); Kumara Swamy KASANI, GodavariKahani (IN); Ligang WU, Suzhou, Jiangsu (CN)

(21) Appl. No.: 19/140,318

(22) PCT Filed: Jan. 2, 2024
(86) PCT No.: PCT/US2024/010007

§ 371 Date: Jun. 17, 2025

Related U.S. Application Data
(60) Provisional application No. 63/437,160, filed on Jan. 5, 2023.

(51) Int. Cl. H01Q 19/00; H01Q 15/00; H01Q 21/06

(52) U.S. Cl. CPC H01Q 19/00; H01Q 15/0013; H01Q 21/062

(57) ABSTRACT

A radiating element comprises a first radiator and a first director that includes first through fourth arms. Each of the first through fourth arms comprises a respective metallization pattern that extends radially from a central metallized region, and the first arm includes a resonant circuit that has at least one inductive element and at least one capacitive element.

### CROSS-REFERENCE TO RELATED APPLICATION

The present application claims priority under 35 U.S.C. 119 to U.S. Provisional Patent Application Ser. No. 63/437,160, filed Jan. 5, 2023, the entire content of which is incorporated herein by reference as if set forth in its entirety.

### BACKGROUND

The present invention generally relates to radio communications and, more particularly, to base station antennas for cellular communications systems.

Cellular communications systems are well known in the art. In a cellular communications system, a geographic area is divided into a series of regions that are referred to as “cells” which are served by respective base stations. The base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly. In many cases, each base station is divided into “sectors.” In one common configuration, a hexagonally shaped cell is divided into three 120° sectors in the azimuth plane, and each sector is served by one or more base station antennas that generate antenna beams having azimuth Half Power Beamwidths (“HPBW”) of approximately 65°, which provides good coverage throughout the 120° sector. Base station antennas that provide less than omnidirectional (360°) coverage in the azimuth plane are often referred to as “sector” base station antennas. The antenna beams formed by both omnidirectional and sector base station antennas are typically generated by linear or planar phased arrays of radiating elements that are included in the antenna.

In order to accommodate the increasing volume of cellular communications, cellular operators have added cellular service in a variety of new frequency bands. While in some cases it is possible to use a single array of so-called “wide-band” or “ultra-wide-band” radiating elements to provide service in multiple frequency bands, in other cases it is necessary to use different arrays of radiating elements to support service in the different frequency bands. However, as the operating bandwidth is increased, it may become difficult to provide desired levels of antenna directivity across the entire operating frequency band.

As the number of frequency bands has proliferated, and increased sectorization has become more common (e.g., dividing a cell into six, nine or even twelve sectors), the number of base station antennas deployed at a typical base station has increased significantly. However, due to, for example, local zoning ordinances and/or weight and wind loading constraints for the antenna towers, there is often a limit as to the number of base station antennas that can be deployed at a given base station. In order to increase capacity without further increasing the number of base station antennas, so-called multi-band base station antennas have been introduced which include multiple arrays of radiating elements. Multi-band base station antennas are now being developed that include arrays that operate in three (or more) different frequency bands and often within multiple sub-bands in one or more of these frequency bands. For example, base station antennas are now being deployed that include two linear arrays of “low-band” radiating elements that operate in some or all of the 617-960 MHz frequency band, two linear arrays of “mid-band” radiating elements that operate in some or all of the 1427-2690 MHz frequency band and one or more multi-column (planar) arrays of “high-band” radiating elements that operate in some or all of a higher frequency band, such as the 3.3-4.2 GHz frequency band. Unfortunately, the different arrays can interact with each other, which may make it challenging to implement such a multi-band antenna while also meeting customer requirements relating to the size (and particularly the width) of the base station antenna.

### SUMMARY

Pursuant to embodiments of the present invention, radiating elements are provided that comprise a first radiator and a first director that includes first through fourth arms. Each of the first through fourth arms comprises a respective metallization pattern that extends radially from a central metallized region, where the first arm includes a resonant circuit that has at least one inductive element and at least one capacitive element.

In some embodiments, the first director is configured to be substantially transparent with respect to RF energy within a first sub-band of an operating frequency band of the radiating element.

In some embodiments, the resonant circuit is configured to be resonant with respect to RF energy within a second sub-band of an operating frequency band of the radiating element.

In some embodiments, the first director is configured to generate surface currents in response to RF energy within a second sub-band of an operating frequency band of the radiating element. In some embodiments, the second sub-band encompasses lower frequencies than the first sub-band.

In some embodiments, the radiating element is part of an array of first radiating elements that are included in a base station antenna, and wherein the first director is configured to be substantially transparent with respect to RF energy within an operating frequency band of an array of second radiating elements that are also included in the base station antenna, where the array of first radiating elements operates at lower frequencies than the array of second radiating elements.

In some embodiments, each metallization pattern includes a plurality of metal segments, and the at least one inductive element comprises a metal trace that interconnects two of the metal segments of the first metallization pattern on the first arm, and wherein an average width of the metal trace is less than half an average width of both of the two metal segments. In some embodiments, the metal trace is a meandered metal trace. In some embodiments, the at least one capacitive element comprises edge coupling between the two metal segments of the first metallization pattern on the first arm.

In some embodiments, the first radiator is a first dipole radiator, wherein the radiating element comprises a cross-dipole radiating element that includes the first dipole radiator and a second dipole radiator, and wherein the first and second arms extend along a first axis that extends parallel to the first dipole radiator and the third and fourth arms extend along a second axis that extends parallel to the second dipole radiator.

In some embodiments, the central metallized region comprises a second director that is configured to narrow an azimuth half power beamwidth of radiation patterns emitted by the radiating element within the first sub-band of the operating frequency band of the radiating element.

In some embodiments, the first through fourth arms of the first director are configured to narrow an azimuth half power beamwidth of radiation patterns emitted by the radiating element within a second sub-band of an operating frequency band of the radiating element.

In some embodiments, the first through fourth arms each comprise a frequency selective surface. In some embodiments, each frequency selective surface includes a plurality of unit cell structures.

In some embodiments, the first director is mounted forwardly of the radiator.

In some embodiments, a resonant frequency of the resonant circuit is within an operating frequency band of the radiating element.

In some embodiments, the radiating element is part of a first array of radiating elements of a base station antenna, the base station antenna further comprising a second array of radiating elements that operate in a second operating frequency band, wherein a resonant frequency of the resonant circuit is within the second operating frequency band.

Pursuant to further embodiments of the present invention, radiating elements are provided that are configured to transmit and receive RF signals in an operating frequency band. These radiating elements comprise a first radiator and a first director that is configured to be substantially transparent to RF energy in a first sub-band of the operating frequency band that is in an upper portion of the operating frequency band.

In some embodiments, the first director is configured to generate surface currents in response to RF energy within a second sub-band of the operating frequency band that is in a lower portion of the operating frequency band.

In some embodiments, the first director includes a resonant circuit, the resonant circuit including at least one inductive element and at least one capacitive element. In some embodiments, a resonant frequency of the resonant circuit is within the operating frequency band.

In some embodiments, the first director includes a plurality of metal segments, and the at least one inductive element comprises a meandered metal trace that interconnects first and second of the metal segments. In some embodiments, the at least one capacitive element comprises edge coupling between the first and second of the metal segments.

In some embodiments, the radiating element comprises a cross-dipole radiating element and the first radiator is a first dipole radiator and the cross-dipole radiating element further includes a second dipole radiator, and wherein the first director includes first and second arms that extend along a first axis that extends parallel to the first dipole radiator and third and fourth arms that extend along a second axis that extends parallel to the second dipole radiator.

In some embodiments, the first director is configured to narrow an azimuth half power beamwidth of radiation patterns emitted by the radiating element within a second sub-band of the operating frequency band, the radiating element further comprising a second director that is configured to narrow an azimuth half power beamwidth of radiation patterns emitted by the radiating element within the first sub-band of the operating frequency band.

In some embodiments, the first director includes a frequency selective surface. In some embodiments, the frequency selective surface comprises a plurality of unit cells.

In some embodiments, the first director comprises a conductive loop. In some embodiments, the conductive loop comprises a plurality of widened conductive segments that are interconnected by a plurality of meandered conductive traces.

Pursuant to additional embodiments of the present invention, radiating elements are provided that are configured to transmit and receive RF signals in an operating frequency band. These radiating elements comprise a first radiator and a first director that is configured to narrow an azimuth half power beamwidth of radiation patterns generated by the first radiator in a lower portion of the operating frequency band and a second director that is configured to narrow an azimuth half power beamwidth of radiation patterns generated by the first radiator in an upper portion of the operating frequency band.

In some embodiments, the first director is configured to be substantially transparent to RF energy in the upper portion of the first operating frequency band.

In some embodiments, the first director includes a resonant circuit, the resonant circuit including at least one inductive element and at least one capacitive element. In some embodiments, a resonant frequency of the resonant circuit is within the lower portion of the operating frequency band.

In some embodiments, the first director includes a plurality of metal segments, and the at least one inductive element comprises a metal trace that interconnects two of the metal segments, wherein an average width of the metal trace is less than half an average width of both of the two of the metal segments. In some embodiments, the metal trace is a meandered metal trace. In some embodiments, the at least one capacitive element comprises edge coupling between the two of the metal segments.

In some embodiments, the radiating element comprises a cross-dipole radiating element that includes the first dipole radiator and a second dipole radiator, and wherein the first director includes first and second arms that extend along a first axis that extends parallel to the first dipole radiator and third and fourth arms that extend along a second axis that extends parallel to the second dipole radiator.

In some embodiments, the first through fourth arms extend from the second director.

In some embodiments, the first director includes a frequency selective surface.

In some embodiments, the first director comprises a conductive loop. In some embodiments, the conductive loop comprises a plurality of widened conductive segments that are interconnected by a plurality meandered conductive traces. In some embodiments, a second director is positioned inside the conductive loop.

Pursuant to still further embodiments of the present invention, radiating elements are provided that comprise a first radiator and a first director that is mounted forwardly of the first radiator, the first director including a frequency selective surface. In some embodiments, the frequency selective surface includes a plurality of unit cell structures. In some embodiments, the frequency selective surface is configured to be substantially transparent with respect to RF energy within a first sub-band of an operating frequency band of the radiating element. In some embodiments, the first sub-band is an upper portion of the operating frequency band of the radiating element.

Pursuant to yet additional embodiments of the present invention, cross-dipole radiating elements are provided that operate in a first operating frequency band. These radiating elements comprise a first dipole radiator, a second dipole radiator that extends perpendicularly to the first dipole radiator, and a first director that includes a plurality of widened conductive segments that are interconnected by a plurality of meandered conductive traces to form a conductive loop that overlaps the first and second dipole radiators.

In some embodiments, the cross-dipole radiating element further comprises a second director that is positioned within the conductive loop.

In some embodiments, the first director is configured to be substantially transparent with respect to RF energy within a first sub-band of the first operating frequency band.

In some embodiments, the first director is configured to be resonant with respect to RF energy within a second sub-band of the first operating frequency band. In some embodiments, the second sub-band encompasses lower frequencies than the first sub-band.

### BRIEF DESCRIPTION OF THE DRAWINGS

FIG. 1 is a perspective view of a base station antenna according to embodiments of the present invention.

FIG. 2 is a front view of the base station antenna of FIG. 1 with the radome removed.

FIG. 3 is a cross-sectional view of the base station antenna of FIG. 1 with the radome removed.

FIGS. 4A-4C are a side view, a perspective view and a front view, respectively, of a conventional mid-band radiating element.

FIGS. 5A-5C are a side view, a perspective view and a front view, respectively, of a radiating element according to embodiments of the present invention that includes two directors where at least one of the directors is a cloaked director.

FIG. 6 is a front view of a portion of a multi-band base station antenna according to embodiments of the present invention that includes mid-band radiating elements that have cloaked directors.

FIGS. 7A and 7B are front views of cloaked directors according to further embodiments of the present invention.

FIG. 8 is a front view of a director according to further embodiments of the present invention that has a frequency selective surface.

### DETAILED DESCRIPTION

Embodiments of the present invention relate generally to radiating elements for base station antennas and to related base station antennas. The base station antennas that include radiating elements according to embodiments of the present invention may be used, for example, as sector antennas in the above-described cellular communications systems.

Radiating elements for base station antennas often include parasitic elements that are called “directors.” Directors are “parasitic” devices in the sense that they are not connected to an RF signal source and instead operate by “collecting” RF energy emitted by actively fed elements of the antenna (e.g., the dipole radiators) and then reradiating this RF energy, as is well understood by those of ordinary skill in the art. A director is a metal element that is used to shape the antenna beams generated by the radiators of a radiating element that includes the director. In most cases, directors are designed to narrow the azimuth HPBW of the individual “element” antenna beams that are generated by the radiators of a radiating element that includes the director. Each director is typically implemented as an electrically floating (i.e., not electrically grounded) piece of sheet metal that is mounted forwardly of the radiators of the radiating element via, for example, a plastic support. The director is typically smaller in size than the radiators, and is often implemented as a square or nearly square piece of metal.

Directors are routinely included in mid-band radiating elements that operate in the 1427-2690 MHz or the 1695-2690 MHz frequency bands. By adding a director to each radiating element in a mid-band linear array, the beamwidth of the generated antenna beams can be narrowed in the azimuth plane, which acts to increase the directivity of the antenna beams.

Unfortunately, because the mid-band frequency range is so large (the full 1427-2690 MHz mid-band frequency range has a fractional bandwidth of (2690-1427)/2690=47% fractional bandwidth), it can be difficult to design a director that will improve the directivity of the radiating element across the full mid-band operating frequency band. In particular, if the director is designed to narrow the azimuth beamwidth in the lower portion of the mid-band frequency range, the size of the director becomes large enough that the director may block some of the emitted RF radiation in the upper portion of the mid-band frequency range. Consequently, conventional directors for mid-band radiating elements are designed to narrow the azimuth beamwidth for RF energy in the upper portion of the mid-band frequency range (e.g., the 2180-2690 MHz frequency range). Such directors have little or no impact on RF energy emitted in the lower portion of the mid-band frequency range. Mid-band radiating elements including such directors may have dipole arms having electrical lengths that are about a quarter wavelength at a frequency in the lower portion of the mid-band frequency range (as opposed to having an electrical length of a quarter wavelength at the center frequency of the mid-band frequency range), as the use of such physically larger dipole arms increases directivity in the lower portion of the mid-band frequency range. However, increased directivity may be needed across the entire mid-band frequency range, and particularly in the lower portion of the mid-band frequency range.

Pursuant to embodiments of the present invention, radiating elements are provided that have so-called “cloaked” directors that are designed to be substantially transparent to RF energy within a sub-band of the operating frequency band of the radiating elements that include the directors. For example, pursuant to embodiments of the present invention, mid-band radiating elements are provided that have cloaked directors that are designed to narrow the azimuth HPBW of RF energy emitted in the lower portion of the mid-band frequency range. The cloaked directors are substantially transparent to RF energy within the upper portion of the mid-band frequency range. These radiating elements can also include non-cloaked directors that are designed to narrow the azimuth HPBW of RF energy emitted in the upper portion of the mid-band frequency range. The radiating elements according to embodiments of the present invention may thus exhibit improved directivity, particularly in the lower portion of the operating frequency band, without negatively impacting performance in the upper portion of the operating frequency band.

In addition, the radiating elements according to embodiments of the present invention may also improve the performance of other arrays included in a base station antenna. In particular, one known challenge in the design of multi-band base station antennas is reducing the effect of scattering of the RF signals at one frequency band by the radiating elements of other frequency bands. Scattering is undesirable as it may affect the shape of the antenna beam in both the azimuth and elevation planes, and the effects may vary significantly with frequency, which may make it hard to compensate for these effects. Moreover, at least in the azimuth plane, scattering tends to impact the beamwidth, beam shape, pointing angle, gain and front-to-back ratio of the antenna beams in undesirable ways.

Dipole-based radiating elements typically have dipole radiators that have an electrical length that is approximately ½ a wavelength of the center frequency of the designed operating frequency band for the radiating element (although, as discussed above, there may be some variation in electrical length to achieve desired performance across the full operating frequency band). The 3.1-4.2 GHz high-band frequency range encompasses frequencies that are twice frequencies in the lower portion of the mid-band frequency range. Consequently, RF energy transmitted by high-band radiating elements may tend to couple to the dipole arms of nearby mid-band radiating elements since such high-band RF energy will be resonant in a dipole arm that has a length of about a ½ wavelength. The coupled RF energy generates high-band currents on the mid-band dipole arms, which in turn generate high-band radiation that is emitted from the mid-band dipole arms. The high-band RF energy emitted from the mid-band dipole arms distorts the antenna beams generated by the high-band arrays since (1) the radiation is being emitted from a different location than intended and (2) the radiation emitted from the mid-band dipole radiators may be out-of-phase with the radiation emitted by the high-band radiating elements.

Cloaking radiating elements are known in the art that are designed to reduce or eliminate such scattering of RF energy emitted by higher frequency band radiating elements by the dipole arms of nearby lower frequency band radiating elements. For example, U.S. Pat. No. 9,570,804 discloses lower-band radiating elements that include dipole arms that are formed as a series of RF chokes in order to render the lower-band radiating element substantially transparent to RF energy emitted by nearby higher-band radiating elements. U.S. Pat. Nos. 10,439,285 and 10,770,803 each disclose lower-band radiating elements that include dipole arms that are formed as a series of widened segments that are coupled by narrow inductive segments, which may be implemented as small, meandered trace segments on a printed circuit board. In each case, the narrow inductive segments act as high impedance elements for RF energy in a higher frequency band, rendering the lower-band radiating elements substantially transparent to RF energy in the higher frequency band. Additional cloaking radiating element designs are disclosed in U.S. Pat. No. 11,018,437, Chinese Patent No. CN 112787061A, Chinese Patent No. CN 112164869A, Chinese Patent No. CN 112290199A, Chinese Patent No. CN 111555030A, Chinese Patent No. CN 112186333A, Chinese Patent No. CN 112186341A, Chinese Patent No. CN 112768895A, Chinese Patent No. CN 112821044A, Chinese Patent No. CN 213304351U, Chinese Patent No. CN 112421219A, and PCT Publication WO 2021/042862.

While the dipole arms of a lower-band radiating element tend to be the primary source of the above-described scattering phenomena, Applicants have discovered that the directors of lower-band radiating elements may also cause some amount of scattering with respect to the RF radiation emitted by nearby higher-band radiating elements. The cloaked directors according to embodiments of the present invention may be designed to be substantially transparent to RF energy not only within the upper portion of the operating frequency band of the radiating elements, but also with respect to RF energy emitted by nearby higher band radiating elements, Thus, the cloaked directors according to embodiments of the present invention may, for example, improve the performance of both the mid-band arrays and the high-band arrays of a multi-band base station antenna.

Pursuant to some embodiments of the present invention, radiating elements are provided that include a first radiator and a first director that includes first through fourth arms. Each of the first through fourth arms comprises a respective metallization pattern that extends radially from a central metallized region, and the first arm includes a resonant circuit that has at least one inductive element and at least one capacitive element. The first director may be configured to be substantially transparent with respect to RF energy within a first sub-band of an operating frequency band of the radiating element. The resonant circuit may be configured to be resonant with respect to RF energy within a second sub-band of an operating frequency band of the radiating element. The second sub-band may encompass lower frequencies than the first sub-band. Moreover, the central metallized region may be a second director that is configured to narrow an azimuth half power beamwidth of radiation patterns emitted by the radiating element within the first sub-band of the operating frequency band of the radiating element.

Pursuant to further embodiments of the present invention, radiating elements are provided that comprise a first radiator and a first director that is configured to be substantially transparent to RF energy in a first sub-band of an operating frequency band of the radiating element, where the first sub-band is in an upper portion of the operating frequency band.

Pursuant to still further embodiments of the present invention, radiating elements are provided that comprise a first radiator and a first director that is configured to narrow an azimuth half power beamwidth of radiation patterns generated by the first radiator in a lower portion of an operating frequency band of the radiating element and a second director that is configured to narrow an azimuth half power beamwidth of radiation patterns generated by the first radiator in an upper portion of the operating frequency band.

Pursuant to yet additional embodiments of the present invention, radiating elements are provided that comprise a first radiator and a first director that is mounted forwardly of the first radiator, the first director including a frequency selective surface.

Pursuant to still additional embodiments of the present invention, radiating elements are provided that comprise a first dipole radiator, a second dipole radiator that extends perpendicularly to the first dipole radiator, and a first director that includes a plurality of widened conductive segments that are interconnected by a plurality of meandered conductive traces to form a conductive loop that overlaps the first and second dipole radiators.

Embodiments of the present invention will now be described in further detail with reference to the attached figures.

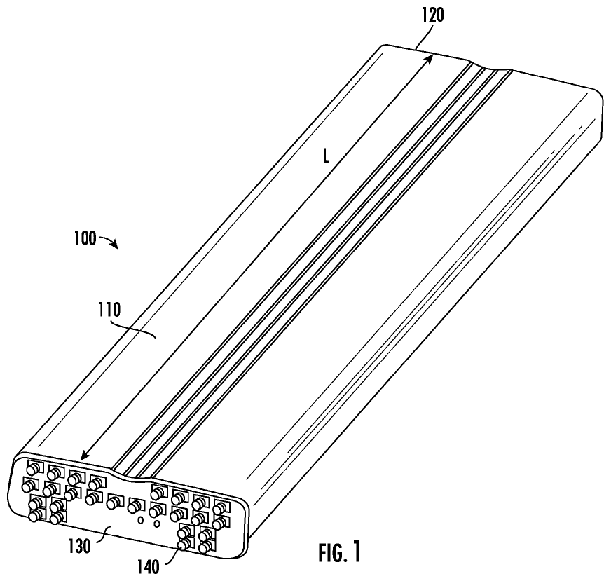

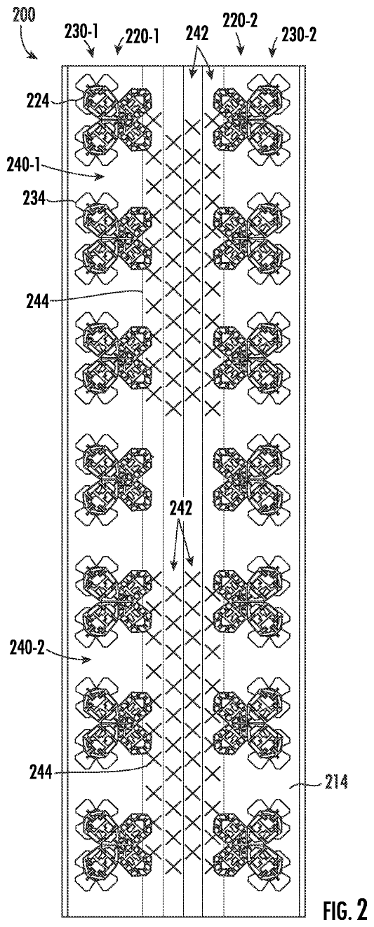

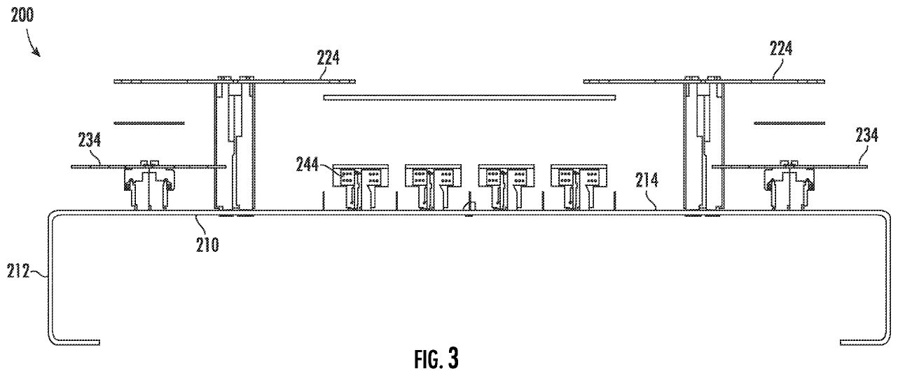

FIGS. 1-3 illustrate a base station antenna 100 according to certain embodiments of the present invention. In particular, FIG. 1 is a perspective view of the antenna 100, while FIGS. 2 and 3 are a front view and a cross-sectional view, respectively, of the antenna 100 with the radome thereof removed to illustrate an antenna assembly 200 of the antenna 100. In the description that follows, the antenna 100 and the radiating elements included therein will be described using terms that assume that the antenna 100 is mounted for normal use on a tower with a longitudinal axis of the antenna 100 extending along a vertical axis and the front surface of the antenna 100 mounted opposite the tower pointing toward the coverage area for the antenna 100.

As shown in FIGS. 1-3, the base station antenna 100 is an elongated structure that extends along a longitudinal axis L. The base station antenna 100 may have a tubular shape with a generally rectangular cross-section. The antenna 100 includes a radome 110 and a top end cap 120. The antenna 100 also includes a bottom end cap 130 which includes a plurality of connectors 140 such as RF ports mounted therein. The antenna 100 is typically mounted in a vertical configuration (i.e., the longitudinal axis L may be generally perpendicular to a plane defined by the horizon) when the antenna 100 is mounted for normal operation. The radome 110, top cap 120 and bottom cap 130 may form an external housing for the antenna 100. An antenna assembly 200 is contained within the external housing. The antenna assembly 200 may be slidably inserted into the radome 110 from either the top or bottom before the top cap 120 or bottom cap 130 are attached to the radome 110.

FIGS. 2 and 3 are a front view and a cross-sectional view, respectively, of the antenna assembly 200 of base station antenna 100. As shown in FIGS. 2 and 3, the antenna assembly 200 includes a ground plane structure 210 that has sidewalls 212 and a reflector surface 214. Various mechanical and electronic components of the antenna (not shown) may be mounted in a chamber that is defined between the sidewalls 212 and the back side of the reflector surface 214 such as, for example, phase shifters, remote electronic tilt units, mechanical linkages, controllers, diplexers, and the like. The reflector surface 214 of the ground plane structure 210 may comprise or include a metallic surface (e.g., a sheet of aluminium) that serves as a reflector and ground plane for the radiating elements of the antenna 100. Herein the reflector surface 214 may also be referred to as the reflector 214.

Dual-polarized radiating elements are mounted to extend forwardly from the reflector 214. The radiating elements include low-band radiating elements 224, mid-band radiating elements 234 and high-band radiating elements 244. The low-band radiating elements 224 are mounted in two columns to form two linear arrays 220-1, 220-2 of low-band radiating elements 224. It should be noted that herein, when multiple like or similar elements are provided, they may be labelled in the drawings using a two-part reference numeral (e.g., the linear arrays 220-1, 220-2). Such elements may be referred to herein individually by their full reference numeral (e.g., linear array 220-2) and may be referred to collectively by the first part of their reference numeral (e.g., the linear arrays 220). The mid-band radiating elements 234 may likewise be mounted in two columns to form two linear arrays 230-1, 230-2 of mid-band radiating elements 234. First and second planar arrays 240-1, 240-2 of high-band radiating elements 244 are included in antenna 100 that each include four columns 242 of high-band radiating elements 244. All four columns 242 of high-band radiating elements 244 in each high-band array 240 may be coupled to four corresponding ports of respective first and second beamforming radios (not shown). As such, each high-band array 240 may perform active beamforming to generate higher gain antenna beams. Herein, the linear arrays 220-1, 220-2 of low-band radiating elements 224 may also be referred to as the low-band linear arrays 220-1, 220-2, the linear arrays 230-1, 230-2 of mid-band radiating elements 234 may also be referred to as the mid-band linear arrays 230-1, 230-2, and the arrays 240-1, 240-2 of high-band radiating elements 244 may also be referred to as high-band arrays 240.

In the depicted embodiment, the two high-band arrays 240-1, 240-2 are positioned between the two low-band arrays 220-1, 220-2, and each linear array 220 of low-band radiating elements 224 is positioned between the high-band arrays 240-1, 240-2 and a respective one of the mid-band linear arrays 230-1, 230-2. Antenna 100 illustrates one typical layout of arrays of low-band, mid-band and high-band radiating elements. Many other array configurations are routinely used based on applications and customer requirements. Thus, it will be appreciated that the number of arrays of low-band, mid-band and/or high-band radiating elements may be varied from what is shown in FIGS. 2 and 3, as may the number of columns and/or radiating elements in each array, and the relative positions of the arrays. For example, the two high-band arrays 240 may be omitted in another example embodiment or replaced with two additional mid-band linear arrays 230. The radiating elements according to embodiments of the invention may be used in arrays having any suitable configuration.

The low-band radiating elements 224 may be configured to transmit and receive signals in a first frequency band. In some embodiments, the first frequency band may comprise the 617-960 MHz frequency range or a portion thereof (e.g., the 617-896 MHz frequency band, the 696-960 MHz frequency band, etc.). The mid-band radiating elements 234 may be configured to transmit and receive signals in a second frequency band. In some embodiments, the second frequency band may comprise the 1427-2690 MHz frequency range or a portion thereof (e.g., the 1695-2690 MHz frequency band, the 1710-2200 MHz frequency band, the 2300-2690 MHz frequency band, etc.). The high-band radiating elements 244 may be configured to transmit and receive signals in a third frequency band. In some embodiments, the third frequency band may comprise the 3100-4200 MHz frequency range or a portion thereof. The two low-band linear arrays 220-1, 220-2 may or may not be configured to transmit and receive signals in the same portion of the first frequency band. For example, in one embodiment, the low-band radiating elements 224 in the first linear array 220-1 may be configured to transmit and receive signals in the 700 MHz frequency band and the low-band radiating elements 224 in the second linear array 220-2 may be configured to transmit and receive signals in the 800 MHz frequency band. In other embodiments, the low-band radiating elements 224 in both the first and second linear arrays 220-1, 220-2 may be configured to transmit and receive signals in the same frequency band to, for example, support the use of multi-input-multi-output (“MIMO”) communication techniques. The mid-band and high-band radiating elements 234, 244 in the different mid-band and high-band arrays 230, 240 may similarly have any suitable configuration. The radiating elements 224, 234, 244 may be dual polarized radiating elements (e.g., −45°/+450 cross-dipole radiating elements or −45°/+45° polarized patch radiating elements), and hence each array 220, 230, 240 may be used to form a pair of antenna beams, namely an antenna beam for each of the two polarizations at which the dual-polarized radiating elements are designed to transmit and receive RF signals.

While not shown in the figures, the radiating elements 224, 234, 244 may be mounted on feed boards that couple RF signals to and from the individual radiating elements 224, 234, 244. One or more radiating elements 224, 234, 244 may be mounted on each feed board. Cables may be used to connect each feed board to other components of the antenna such as diplexers, phase shifters or the like.

As discussed above, mid-band radiating elements such as radiating elements 234 often include directors that are used to narrow the azimuth HPBW of the generated “element” radiation patterns (i.e., the antenna beam generated by an individual radiating element). However, in practice, the directors may only be designed to narrow the element radiation pattern for RF energy in the upper portion of the mid-band frequency range, such as, for example, the 2180-2690 MHz frequency range or the 2300-2690 MHz frequency range. As such, these conventional radiating elements may exhibit directivity values in the lower portion of the mid-band frequency range that are less than desirable.

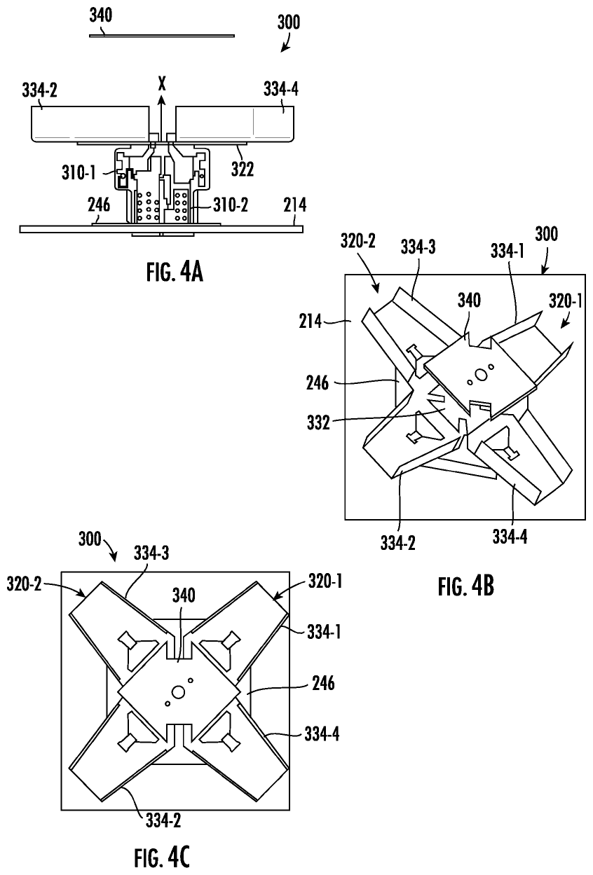

FIGS. 4A-4C illustrate a conventional mid-band radiating element 300 that includes a director that only narrows the azimuth beamwidth in the upper portion of the mid-band frequency range. In particular, FIG. 4A is a side view of the radiating element 300, FIG. 4B is a perspective front view of the radiating element 300, and FIG. 4C is a front view of the radiating element 300. The radiating element 300 includes a feed stalk 310, first and second dipole radiators 320-1, 320-1, and a director 340.

A first of the feed stalks 310-1 may include a front slit and the second of the feed stalks 310-2 includes a back slit. These slits allow the two feed stalks 310 to be assembled together to form a forwardly extending column that has generally x-shaped vertical cross-sections. Rear portions of each feed stalk 310 may include projections that are inserted through slits in a feed board 246 to mount the radiating element 300 thereon. The feed board 246 may be mounted on the reflector 214 of a base station antenna. In some embodiments, each feed stalk 310 may comprise a printed circuit board that has an RF transmission line formed thereon. The RF transmission lines carry RF signals between a feed board 246 and the dipole radiators 320. The dipole radiators 320 are mounted at the forward end of the feed stalks 310. The RF transmission lines center feed the dipole radiators 320-1, 320-2.

In the depicted embodiment, the first and second dipole radiators 320-1, 320-2 are formed using a dipole radiator printed circuit board 322 and sheet metal dipole arm extensions 334-1 through 334-4. The first dipole radiator 320-1 includes first and second dipole arms 330-1, 330-2, and the second dipole radiator 320-2 includes third and fourth dipole arms 330-3, 330-4. As shown in FIGS. 4B and 4C, the dipole radiators 320-1, 320-2 may be implemented in a “cross” arrangement to form a pair of center-fed −45°/+45° dipole radiators 320. An inner portion 332 of each dipole arm 330 may be formed on the dipole radiator printed circuit board 322. The inner portion 332 of each dipole arm 330 may be capacitively coupled to a respective one of the dipole arm extensions 334. Together, the inner portion 332 of each dipole arm 332 and the dipole arm extension 334 that is capacitively coupled thereto form the respective dipole arms 330-1 through 330-4.

The director 340 is mounted forwardly of the dipole radiators 320. The director 340 may comprise a flat piece of stamped sheet metal. A plastic support (not shown) may be used to mount the director 340 in its proper position. The director 340 is substantially smaller than the dipole radiators 320. The director 340 extends further in the horizontal plane than the vertical plane, which allows the director to narrow the radiation patterns generated by its associated dipole radiators 320 more in the azimuth plane than in the elevation plane.

The director 340 is designed to narrow the azimuth beamwidth of the radiation patterns generated by its associated dipole radiators 320 in the 2180-2690 MHz frequency range. The director 340 has very little impact on the radiation patterns generated by its associated dipole radiators 320 in the 1427-1980 MHz frequency range. Directors having slightly different sizes may be used to target specific sub-ranges within the 2180-2690 MHz frequency range. The distance that the director 340 is mounted forwardly of the dipole radiators 320 may be set to tune the shape of the radiation pattern in the azimuth plane.

The director 340 can be effective in narrowing the azimuth beamwidth in the upper portion of the mid-band frequency range. For example, simulations indicate that the radiating element 300 exhibits an average azimuth HPBW of 64.9° in the 2300-2690 MHz frequency range, as compared to an average azimuth HPBW of 71.6° in the 1695-2180 MHz frequency range. The larger dipole arms 330 help provide an average azimuth HPBW of 58.6° in the 1427-1518 MHz frequency range. However, smaller azimuth HPBWs would be desirable in all three frequency ranges and, in particular, in the 1427-1518 MHz and 1695-2180 MHz frequency bands.

Radiating element 300 is discussed in detail in U.S. Patent Publication No. 2022/0190470 filed Sep. 25, 2021, the entire content of which is incorporated herein by reference. As such, further description of radiating element 300 will be omitted here.

Pursuant to embodiments of the present invention, radiating elements are provided that have directors that are configured to narrow the azimuth beamwidth of the radiation pattern generated by the dipole radiators of the radiating element in a first portion of an operating frequency band of the radiating element while being significantly more transparent to RF energy in a second portion of the operating frequency band of the radiating element. For example, the directors may be configured to narrow the azimuth beamwidth of the radiation pattern generated by the dipole radiators of the radiating element in a lower portion of the operating frequency band of the radiating element while being substantially transparent to RF energy in an upper portion of the operating frequency band. Such directors can improve the shape and/or directivity of the antenna beams generated by the dipole radiators in the lower portion of the operating frequency band without adversely effecting the radiation patterns generated by the radiating elements in the upper portion of the operating frequency band.

In some embodiments, the radiating elements may include both first and second directors. As discussed above, the first director may be a “cloaking” director that is configured to improve the shape and/or directivity of the antenna beams generated by the dipole radiators in the lower portion of the operating frequency band without adversely affecting the radiation patterns generated by the radiating elements in the upper portion of the operating frequency band. The second director can be, for example, a director that is designed to narrow the azimuth beamwidth of the radiation pattern generated by the dipole radiators of the radiating element in the upper portion of the operating frequency band of the radiating element. Thus, the radiating elements according to embodiments of the present invention can provide improved performance as compared to conventional radiating elements.

In some embodiments, the radiating elements may be mid-band radiating elements that are configured to operate in the 1427-2690 MHz frequency band. In such embodiments, the first director may be configured, for example, to narrow the azimuth beamwidth of radiation patterns generated by RF signals in the 1427-1920 MHz frequency range, while the second director may be configured, for example, to narrow the azimuth beamwidth of radiation patterns generated by RF signals in the 2180-2690 MHz frequency range. In some embodiments, the first and second directors may be implemented as a unitary director element such as a director printed circuit board or a piece of sheet metal. A central portion of the director element may act as the second director (and also may act as part of the first director), and an outer portion of the director element may act as the remainder of the first director.

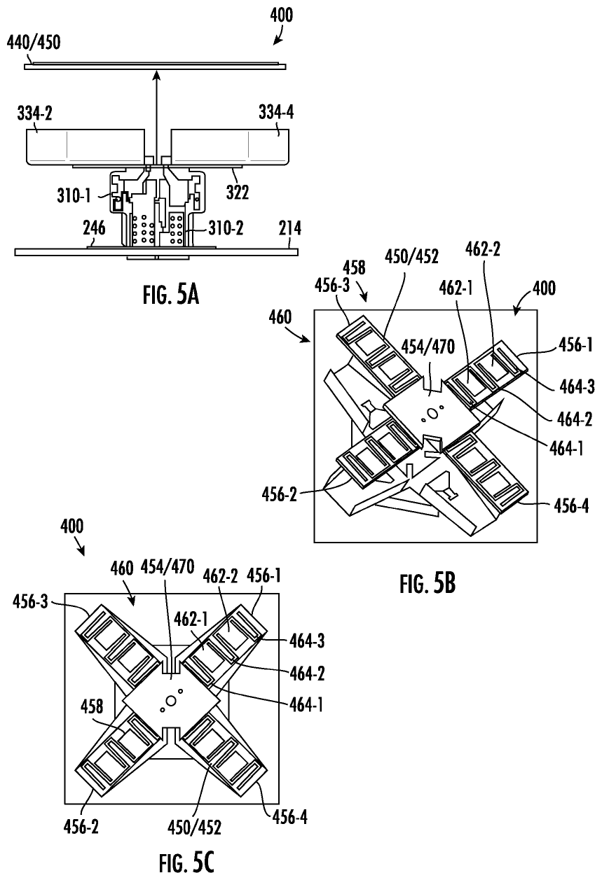

Examples of radiating elements according to embodiments of the present invention that include cloaking directors and/or first and second directors will now be discussed with reference to FIGS. 5A-8. While these example embodiments describe mid-band radiating elements, it will be appreciated that embodiments of the present invention are not limited thereto. For example, in other embodiments, the radiating elements can be high-band radiating elements that have first and second directors that are configured to act as directors in different parts of the high-band frequency range (where one or both of the directors may be cloaking directors).

FIGS. 5A-5C illustrate an example radiating element 400 according to embodiments of the present invention. In particular, FIG. 5A is a side view of the radiating element 400, FIG. 5B is a perspective view of the radiating element 400, and FIG. 5C is a front view of the radiating element 400.

The radiating element 400 may be similar or identical to the radiating element 300 of FIGS. 4A-4C, except that radiating element 400 may include a director element 440 in place of the director 340 included in radiating element 300. Thus, the components of radiating element 400 that may be identical to the corresponding elements of radiating element 300 are identified using the same reference numerals, and further discussion of these elements will be omitted.

In the depicted embodiment, director element 440 is implemented on a director printed circuit board 450. The director printed circuit board 450 may comprise a dielectric substrate 452 that has a metal pattern 458 printed on a first side thereof. A metal pattern 458 is formed on the dielectric substrate 452. The metal pattern 458 includes a central section 454 and first through fourth arms 456-1 through 456-4 that extend outwardly from the central section 454. The arms 456-1 through 456-4 extend from the central section 454 at angles of +45°, +135°, −135° and −45°. Thus, the first and second arms 456-1, 456-2 extend along a first axis that extends parallel to the first dipole radiator 320-1 and the third and fourth arms 456-3, 456-4 extend along a second axis that extends parallel to the second dipole radiator 320-2. The metal pattern 458 forms a first director 460 and a second director 470. The director printed circuit board 450 is mounted forwardly of the first and second dipole radiators 320-1, 320-2. Thus, the first and second directors 460, 470 are also mounted forwardly of the first and second dipole radiators 320-1, 320-2.

The second director 470 comprises a metallization pattern that is formed in the central section 454 of the director printed circuit board 450. The second director 470 is configured to narrow an azimuth half power beamwidth of radiation patterns emitted by the radiating element 400 within a first (upper) sub-band of the operating frequency band of radiating element 400. In some embodiments, the second director 470 may have the same shape and size as the director 340 included in radiating element 300, with the only difference between the two directors 340, 470 being that the second director 470 is implemented as metallization on a printed circuit board while director 340 is implemented using sheet metal (and may be a thicker metal layer than the second director 470).

The first director 460 is configured to be visible to RF energy within the lower portion of the operating frequency band of radiating element 400. Thus, in response to such radiation, surface currents are generated on the first director 400, and these surface currents generate RF radiation from the first director 460 in the lower portion of the operating frequency band. The first director 460 is configured so that the emission of RF radiation in the lower portion of the operating frequency band therefrom acts to narrow an azimuth half power beamwidth of radiation patterns emitted by the radiating element 400 within the lower portion of the operating frequency band. In addition, the first through fourth arms 456-1 through 456-4 are configured to be substantially transparent to RF energy within the first (upper) sub-band of the operating frequency band of radiating element 400. Consequently, the first director 460 is substantially transparent to RF energy within the first (upper) sub-band of the operating frequency band of radiating element 400, as the only portion of the first director 460 that is visible to RF energy within the first (upper) sub-band of the operating frequency band is the portion thereof that acts as the second director 470.

The first director 460 comprises the remainder of the metallization pattern on the director printed circuit board 450, which comprises the four metallization arms 456-1 through 456-4. Moreover, the metallization pattern that is formed in the central section 454 of the director printed circuit board 450 may act as both the second director 470 and also as part of the first director 460. Thus, the first through fourth metal arms 456-1 through 456-4, in conjunction with the central section 454 form the first director 460. As can be seen, the metallization pattern forming each arm 456 comprises first and second widened metal segments 462-1, 462-2 and three narrow metal segments 464-1 through 464-3. The first narrow metal segment 464-1 electrically connects the central section 454 to the first widened metal segments 462-1. The second narrow metal segment 464-2 electrically connects the first widened metal segments 462-1 to the second widened metal segments 462-2. The third narrow metal segment 464-3 extends outwardly from the third widened metal segments 462-3. Thus, on each arm 456, the first and second widened metal segments 462-1, 462-2 and the first through third narrow metal segments 464-1 through 464-3 are electrically connected in series to the central section 454, and extend outwardly along an axis from the central section 454.

The first and second widened metal segments 462-1, 462-2 may each have a first average width (where the width direction is perpendicular to the longitudinal axis of the arm 456) and the three narrow metal segments 464-1 through 464-3 may each have a second average width. In some embodiments, the first average width of at least some of the first and second widened metal segments 462-1, 462-2 may be at least twice, at least three times, at least four times or at least five times the second average width of at least some of the three narrow metal segments 464-1 through 464-3.

Each narrow metal segment 464 is implemented as a meandered segment so that the length of the segment (if extended into a straight line) is much longer than the width of the segment. As a result, the inductance of each narrow metal segment 464 may be much larger than the inductance of the widened metal segments 462. Moreover, since the narrow metal segments 464 are formed as U-shaped metal segments, the two widened metal segments 462 on each arm 456 may be in close proximity to each other so that the two widened conductive segments 462 along with a portion of the central section 454 together appear as a single continuous metal arm at frequencies within a lower portion of the operating frequency range of the radiating element 400. The narrowed meandered segments 464 act as high impedance sections that interrupt currents in the upper portion of the operating frequency range of the radiating element 400 that would otherwise be induced on the arms of the first director 460. In other words, each arm 456 may act like a low-pass (or band-pass) filter that allows currents in the lower portion of the operating frequency range to form on the arm 456 while attenuating currents in the upper portion of the operating frequency range. Each arm 456 may include a respective resonant circuit that has at least one inductive element (e.g., the meandered narrow metal segments 464) and at least one capacitive element (e.g., edge capacitances between the widened metal segments 462 and/or between the widened metal segments 462 and the narrow metal segments 464). Each resonant circuit may be configured to be resonant within an operating frequency band of the radiating element 400. For example, each resonant circuit may be configured to be resonant with respect to RF energy within a second sub-band (e.g., a lower sub-band) of an operating frequency band of the radiating element.

Thus, RF energy emitted by radiating element 400 in the lower portion of the operating frequency band will induce currents on the first director 460, and these currents will cause RF energy to radiate from the first director 460. The first director 460 is positioned so that RF energy emitted by dipole radiators 320-1, 320-2 is substantially in-phase with the RF energy emitted by the first director 460 when the RF energy emitted by the dipole radiators 320-1, 320-2 reaches the first director 460. The phase difference ψ between the current I1 that flows on one of the dipole arms 330 and the current I2 that flows on the corresponding arm of the first director 460 may be determined as follows:

$$ψ = π + arctan ( {x}_{21} / {R}_{21} ) - arctan ( {x}_{11} / {R}_{11} )$$

where x₂₁ is the imaginary component of the mutual impedance between the dipole arm 330 and the metal arm of the first director 440, R₂₁ is the real component of the mutual impedance between the dipole arm 330 and the metal arm of the first director 440, x₁₁ is the imaginary component of the self-impedance of the metal arm the first director 440, and R₁₁ is the real component of the self-impedance of the metal arm the first director 440.

Based on the above formula, it is possible to adjust the phase difference between I1 and I2 by changing the self-impedance and the mutual impedance values. The phase difference may be adjusted to increase the directivity of the radiating element 400. The mutual impedance may be changed, for example, by changing the distance between the dipole radiators 320 and the director printed circuit board 450. The self-impedance of the first director 460 may be changed, for example, by changing the dimensions or size of the first director 460, or the shape or size of the metal segments forming the first director 460. As such, the radiating element 400 may be designed so that the RF energy emitted by the dipole radiators 320 and the corresponding metal arms of the first director 460 are in-phase (or at least relatively close to being in-phase) when the RF energy combines. When this happens, the first director 460 acts to focus the RF energy, thereby narrowing both the azimuth beamwidth and the elevation beamwidth of the element pattern of radiating element 400, thereby increasing the directivity of the RF radiation emitted by radiating element 400 with respect to RF energy in the lower portion of operating frequency band of radiating element 400. Moreover, the first director 460 has very little impact on the radiation patterns generated by its associated dipole radiators 320 in the upper portion of the operating frequency band (e.g., it does not partially block radiating in this frequency band), and thus the first director 460 does not act to degrade the performance of the radiating element 400 in the upper portion of the operating frequency band.

The radiating element 400 exhibits improved performance as compared to the conventional radiating element 300. For example, simulations indicate that the radiating element 400 exhibits an average azimuth HPBW of 63.3° in the 2300-2690 MHz frequency band, which is 1.6° narrower than the average azimuth HPBW of radiating element 300 in this portion of the operating frequency band. Simulations likewise indicate that the radiating element 400 exhibits an average azimuth HPBW of 69.1° in the 1695-2180 MHz frequency band, which is 2.5° narrower than the average azimuth HPBW of radiating element 300 in this portion of the operating frequency band. Simulations further indicate that the radiating element 400 exhibits an average azimuth HPBW of 55.4° in the 1427-1518 MHz frequency band, which is 3.2° narrower than the average azimuth HPBW of radiating element 300 in this portion of the operating frequency band. Because of these narrowed azimuth HPBWs, the directivity of the radiating element 400 is 0.27 dBi, 0.15 dBi and 0.1 dBi larger than the directivity of the radiating element 300 in the 1427-1518 MHz, 1695-2180 MHz and 2300-2690 MHz frequency bands, respectively.

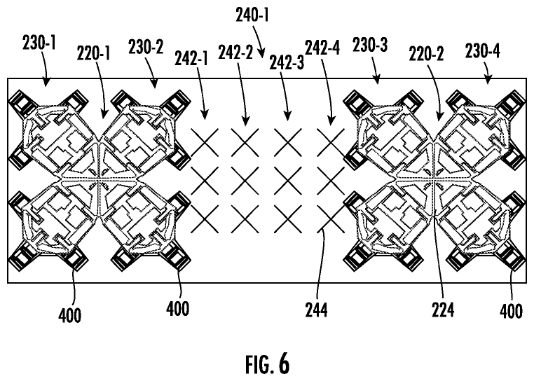

As discussed above, mid-band radiating element 400 may exhibit improved performance as compared to a comparable conventional radiating element 300. The use of cloaking directors, however, may also improve the performance of nearby arrays that operate in higher frequency bands when the radiating elements 400 are used in multi-band base station antennas. This can be seen with reference to FIG. 6.

In particular, FIG. 6 is a front view of a portion of a multi-band base station antenna 500 that includes mid-band linear arrays that are implemented using the above-discussed mid-band radiating elements 400 according to embodiments of the present invention. The base station antenna 500 may, for example, be similar to base station antenna 100 that is discussed above with reference to FIGS. 1-3, with the primary differences being that (1) base station antenna 500 includes four linear arrays 230 of mid-band radiating elements as opposed to the two mid-band arrays 230 included in base station antenna 100 and (2) the mid-band radiating elements are implemented using the above-discussed mid-band radiating elements 400. Thus, the components of base station antenna 500 are labelled using the same reference numerals used in FIGS. 1-3, and further description of these components is omitted.

As noted above, the high-band radiating elements 244 are designed to operate in the 3.1-4.2 GHz frequency band. As such, the RF energy emitted by the high-band radiating elements 244 will tend to be resonant with respect to structures that are resonant in the lower portion of the 1427-2690 MHz operating frequency band of the mid-band radiating elements. Consequently, if the first director 460 that is included in the mid-band radiating elements 400 was not a cloaked director, then RF energy emitted by the high-band radiating elements 244 would induce currents on the arms of the first director 460, since the mid-band radiating elements 400 are mounted in close proximity to the high-band radiating elements 244. However, since the first directors 460 may be substantially invisible to RF energy emitted by the high-band radiating elements 244, the mid-band radiating elements 400 may have reduced impact on the radiation patterns of the high-band arrays 240.

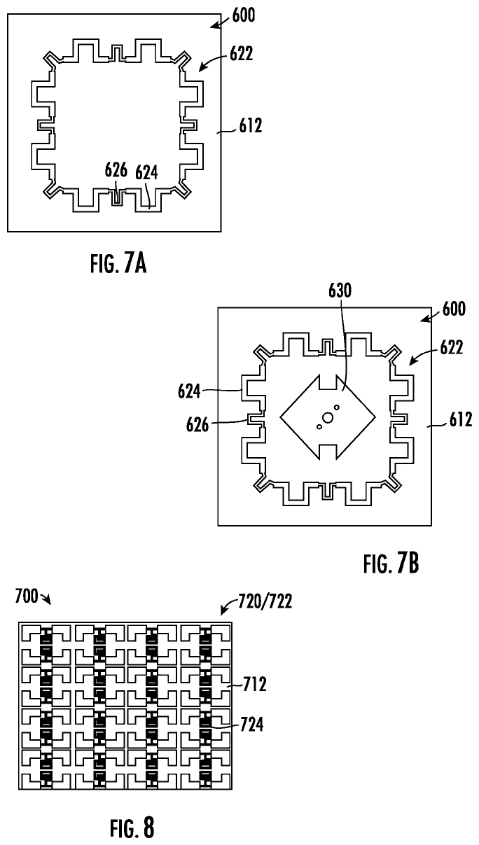

FIGS. 7A and 7B are front views of radiating elements having cloaked directors according to further embodiments of the present invention. As shown in FIG. 7A, a director element 600 comprises a conductive loop that is formed on a director printed circuit board 610. Director element 600 could be used, for example, in place of the director element 440 of radiating element 400.

As shown in FIG. 7A, director element 600 comprises a metallization pattern 622 on a surface (or on multiple surfaces) of a dielectric substrate 612 of the director printed circuit board 610. The metallization pattern 622 forms a first director 620. The metallization pattern 622 may comprise a plurality of relatively wider metal segments 624 that are physically and electrically connected to each other via a plurality of relatively narrower metal traces 626. An average thickness of the relatively wider metal segments 624 may be at least two times, at least three times, at least four times or at least five times an average thickness of the relatively narrower metal traces 626 in example embodiments. As shown, at least some of the relatively narrower metal traces 626 may be implemented as meandered trace segments, which allows the length of the relatively narrower metal traces 626 to be increased significantly (as compared to the width of the trace) while still allowing adjacent ones of the relatively wider metal segments 624 to be positioned in close proximity to each other. The edge capacitances between the relatively wider metal segments 624 and the relatively narrower metal traces 626 along with the inductances of the relatively narrower metal traces 626 may be selected to form a filter that passes RF currents in, for example, the lower portion of the operating frequency band of a radiating element that includes director element 600 while attenuating RF currents in the upper portion of the operating frequency band of the radiating element. In other words, the first director 620 may act like a low-pass filter that is tuned to have a transition between a pass band and a stop band within the operating frequency band of the radiating element that includes the first director 620. Thus, the first director 620 may perform the same function as the first director 460 of radiating element 400. In the depicted embodiment, the relatively wider metal segments 624 are implemented as meandered segments that allow the length of these segments to be substantially larger than the width thereof. In this manner, the relatively wider metal segments 624 may also contribute to the inductance of the filter formed by the first director 600.

FIG. 7B is a front view of a director element 600A that is a modified version of the director element 600 of FIG. 7A. As can be see, director element 600A may be identical to director element 600 except that director element 600A further includes a second director 630 that is implemented in the middle of the conductive loop of the first director 620. The second director 630 may have the exact same design as the second director 470 of radiating element 400 and may perform the same function as the second director 470 of radiating element 400. Thus, further description of director element 600A will be omitted.

Pursuant to further embodiments of the present invention, directors for radiating elements are provided that are implemented as frequency selective surfaces. A frequency selective surface refers to a conductive structure (usually metal) that comprise a plurality of unit cells. The frequency selective surface may be visible to RF energy in some frequency ranges while being substantially transparent to RF energy in other frequency ranges.

As described above, in some cellular frequency bands, including the mid-band frequency range and the high-band frequency range, it may be difficult to design a director that focuses the RF energy in the lower portion of the operating frequency band in the azimuth plane, because the size of the director necessary to perform such focusing is large enough that the director acts to block some of the RF energy in the high portion of the operating frequency band. However, by fabricating directors that focus RF energy in the lower portion of the operating frequency band using a frequency selective surface that is substantially transparent to RF energy in the higher portion of the operating frequency band, it is possible to form directors that focus RF energy in the lower portion of the operating frequency band without negatively impacting the performance of the radiating element in the upper portion of the operating frequency band.

FIG. 8 is a front view of a director element 700 that is formed as a frequency selective surface according to further embodiments of the present invention. Director element 700 could be used, for example, in place of the director element 440 of radiating element 400.

As shown in FIG. 8, director element 700 comprises a metallization pattern 722 on a surface (or on multiple surfaces) of a dielectric substrate 712 of a director printed circuit board 710. The metallization pattern 722 forms a first director 720. The metallization pattern 722 may comprise a plurality of unit cells 724, each of which may have a length and a width that are less than one tenth a frequency in the operating frequency band of the radiating element that includes director element 700. Each unit cell 724 may include individual metallized structures that are arranged to form capacitors and inductors. Thus, each unit cell 724 may comprise one or more resonant circuits. The resonant circuits of the unit cell 724 are configured to provide a desired frequency response, as is understood by those of skill in the art. The desired frequency response may be that the unit cells are substantially transparent to RF energy in the upper portion of the operating frequency band of the radiating element that includes director 700, while being visible to RF energy in the lower portion of the operating frequency band of the radiating element that includes director 700. The size of the first director 720 may be selected so that the first director is resonant to RF energy in the lower portion of the operating frequency band. As a result, RF energy in the lower portion of the operating frequency band that is emitted by the dipole radiators of the radiating element may form RF currents on the first director 720, which in turn results in RF radiation from the first director 720 that is in-phase with the RF energy emitted by the dipole radiators of the radiating element that includes the first director 720. This acts to narrow the HPBW of the antenna beam generated by the radiating element in the azimuth plane for RF signals in the lower portion of the operating frequency band.

It will be appreciated that FIG. 8 illustrates one example frequency selective surface. A wide variety of frequency selective surfaces are known in the art, and any appropriate frequency selective surface design may be used to implement the directors according to embodiments of the present invention. It will also be appreciated that many frequency selective surfaces are multi-layer frequency selective surfaces, and that such multi-layer frequency selective surfaces may be used in place of the single layer frequency selective surface illustrated in the example embodiment of FIG. 8.

While the embodiments of the present invention discussed above include passive directors that are mounted forwardly of the dipole radiators, it will be appreciated that embodiments of the present invention are not limited thereto. In particular, in other embodiments, the director may be positioned behind the dipole radiators (i.e., between the dipole radiators and the reflector). In this position, the director acts like a reflector as opposed to a director, and can once again be designed to increase the directivity of the radiating element.

While the directors described above are implemented using printed circuit boards, it will be appreciated that embodiments of the present invention are not limited thereto. For example, in other embodiments, any of the above-described directors may be implemented using sheet metal or a combination of sheet metal and printed circuit board elements. In such embodiments, the directors may be formed by stamping the appropriately shaped structures from sheet metal.

It will be appreciated that the radiating elements according to embodiments of the present invention are not limited to having dipole arms with the shape of the dipole arms 330 discussed above. Instead, the dipole arms may have any appropriate shape such as line shapes, circular shapes, oval shapes, square shapes, etc.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radiating element, comprising:
a first radiator; and
a first director that includes first through fourth arms, where each of the first through fourth arms comprises a respective metallization pattern that extends radially from a central metallized region, where the first arm includes a resonant circuit that has at least one inductive element and at least one capacitive element.

2. The radiating element of claim 1, wherein the first director is configured to be substantially transparent with respect to radio frequency (“RF”) energy within a first sub-band of an operating frequency band of the radiating element.

3. The radiating element of claim 2, wherein the resonant circuit is configured to be resonant with respect to RF energy within a second sub-band of an operating frequency band of the radiating element.

4. (canceled)

5. The radiating element of claim 3, wherein the second sub-band encompasses lower frequencies than the first sub-band.

6. (canceled)

7. The radiating element of claim 1, wherein each metallization pattern includes a plurality of metal segments, and the at least one inductive element comprises a metal trace that interconnects two of the metal segments of the first metallization pattern on the first arm, and wherein an average width of the metal trace is less than half an average width of both of the two metal segments.

8-9. (canceled)

10. The radiating element of claim 2, wherein the first radiator is a first dipole radiator, wherein the radiating element comprises a cross-dipole radiating element that includes the first dipole radiator and a second dipole radiator, and wherein the first and second arms extend along a first axis that extends parallel to the first dipole radiator and the third and fourth arms extend along a second axis that extends parallel to the second dipole radiator.

11. The radiating element of claim 10, wherein the central metallized region comprises a second director that is configured to narrow an azimuth half power beamwidth of radiation patterns emitted by the radiating element within the first sub-band of the operating frequency band of the radiating element.

12. The radiating element of claim 11, wherein the first through fourth arms of the first director are configured to narrow an azimuth half power beamwidth of radiation patterns emitted by the radiating element within a second sub-band of an operating frequency band of the radiating element.

13. The radiating element of claim 1, wherein the first through fourth arms each comprise a frequency selective surface.

14-17. (canceled)

18. A radiating element that is configured to transmit and receive radio frequency (“RF”) signals in an operating frequency band, the radiating element comprising:
a first radiator; and
a first director that is configured to be substantially transparent to RF energy in a first sub-band of the operating frequency band that is in an upper portion of the operating frequency band.

19. The radiating element of claim 18, wherein the first director is configured to generate surface currents in response to RF energy within a second sub-band of the operating frequency band that is in a lower portion of the operating frequency band.

20-23. (canceled)

24. The radiating element of claim 18, wherein the radiating element comprises a cross-dipole radiating element and the first radiator is a first dipole radiator and the cross-dipole radiating element further includes a second dipole radiator, and wherein the first director includes first and second arms that extend along a first axis that extends parallel to the first dipole radiator and third and fourth arms that extend along a second axis that extends parallel to the second dipole radiator.

25. The radiating element of claim 24, wherein the first director is configured to narrow an azimuth half power beamwidth of radiation patterns emitted by the radiating element within a second sub-band of the operating frequency band, the radiating element further comprising a second director that is configured to narrow an azimuth half power beamwidth of radiation patterns emitted by the radiating element within the first sub-band of the operating frequency band.

26-27. (canceled)

28. The radiating element of claim 18, wherein the first director comprises a conductive loop.

29. (canceled)

30. A radiating element that is configured to transmit and receive radio frequency (“RF”) signals in an operating frequency band, comprising:
a first radiator; and
a first director that is configured to narrow an azimuth half power beamwidth of radiation patterns generated by the first radiator in a lower portion of the operating frequency band and a second director that is configured to narrow an azimuth half power beamwidth of radiation patterns generated by the first radiator in an upper portion of the operating frequency band.

31-36. (canceled)

37. The radiating element of claim 30, wherein the radiating element comprises a cross-dipole radiating element that includes the first dipole radiator and a second dipole radiator, and wherein the first director includes first and second arms that extend along a first axis that extends parallel to the first dipole radiator and third and fourth arms that extend along a second axis that extends parallel to the second dipole radiator.

38. The radiating element of claim 37, wherein the first through fourth arms extend from the second director.

39. (canceled)

40. The radiating element of claim 30, wherein the first director comprises a conductive loop.

41. The radiating element of claim 40, wherein the conductive loop comprises a plurality of widened conductive segments that are interconnected by a plurality meandered conductive traces.

42. The radiating element of claim 40, wherein a second director is positioned inside the conductive loop.

43-51. (canceled)
